(19) United States
(12) Patent Application Publication
(10) Pub. No.: US 2026/0355621 A1
(43) Pub. Date: Nov. 12, 2026

(54) Ergonomic Modular Video Game Controller

(71) Applicant: COGITO LLC, Las Vegas, NV (US)

(72) Inventors: Travis Mow, Henderson, NV (US); David Michael Rowley, Monroe, WA (US)

(21) Appl. No.: 19/674,047

(22) Filed: May 11, 2026

Related U.S. Application Data
(63) Continuation-in-part of application No. 30/022,296, filed on Sep. 9, 2025.
(60) Provisional application No. 63/803,189, filed on May 9, 2025.

(51) Int. Cl. A63F 13/24; G05G 9/047; H01H 13/84; H01R 13/04; H01R 13/62

(52) U.S. Cl. CPC A63F 13/24; G05G 9/047; H01H 13/84; H01R 13/04; H01R 13/6205

(57) ABSTRACT

Disclosed is an ergonomic modular video game controller intended to enhance user comfort, response efficiency, and prolonged usability by incorporating modular and anthropometric design principles tailored for gaming and digital interface control.

### CROSS-REFERENCE TO RELATED APPLICATION

The current application claims a priority to the U.S. provisional patent application serial number 63/803,189 filed on May 9, 2025. The current application is filed on May 11, 2026, while May 9, 2026 was on a weekend.

The current invention is also a continuation-in-part (CIP) application of the U.S. design application serial number 30/022,296 filed on Sep. 9, 2025.

### FIELD OF THE INVENTION

The present invention relates generally to video game controllers. More specifically, an ergonomically designed video game controller intended to enhance user comfort, response efficiency, and prolonged usability by incorporating modular and anthropometric design principles tailored for gaming and digital interface control.

### BACKGROUND OF THE INVENTION

Conventional video game controllers often fail to address prolonged user comfort and natural hand posture. The standard configurations place the primary action buttons, directional pads (d-pads), and analog thumb sticks in positions that require repeated overextension of the thumbs and awkward wrist angles, especially over extended gaming sessions. This leads to user fatigue, strain injuries, and reduced performance.

Moreover, existing controllers generally concentrate all interactive components on the front-facing surface, requiring the user to relinquish control of the analog sticks to press action buttons. This structural flaw limits simultaneous input capabilities and diminishes competitive gaming performance.

There is a clear need for a video game controller that promotes ergonomic health, facilitates simultaneous input functionality, and accommodates diverse hand dominance (left-handed, right-handed, and ambidextrous users) while being modular and customizable for different body postures and playing styles.

### BRIEF DESCRIPTION OF THE DRAWINGS

FIG. 1 is an illustration of the Bridge Only Front Top Angled View.

FIG. 2 is an illustration of the Bridge Only Left Side View.

FIG. 3 is an illustration of the Bridge Only Rear View.

FIG. 4 is an illustration of the Bridge Only Right Side View.

FIG. 5 is an illustration of the Bridge Only Side Angled View.

FIG. 6 is an illustration of the Controller Bottom View.

FIG. 7 is an illustration of the Controller Front Top Angled View.

FIG. 8 is an illustration of the Controller Front View.

FIG. 9 is an illustration of the Controller Left Right Only Front Top Angled View.

FIG. 10 is an illustration of the Controller Left Right Only Rear View.

FIG. 11 is an illustration of the Controller Left Right Only Side Angled View.

FIG. 12 is an illustration of the Controller Left Side View.

FIG. 13 is an illustration of the Controller Rear Bottom Angled View.

FIG. 14 is an illustration of the Controller Rear View.

FIG. 15 is an illustration of the Controller Right Side View.

FIG. 16 is an illustration of the Controller Side Angled View.

FIG. 17 is an illustration of the Controller Top View.

FIG. 18 is an illustration of the Controller without Bridge Front Angled View.

### DETAILED DESCRIPTION OF THE INVENTION

All illustrations of the drawings are for the purpose of describing selected versions of the present invention and are not intended to limit the scope of the present invention.

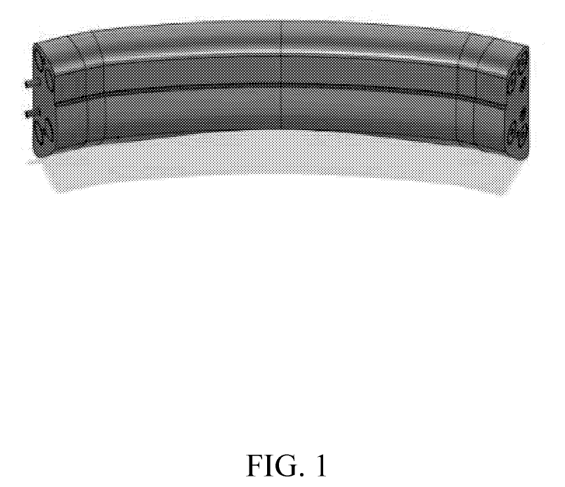

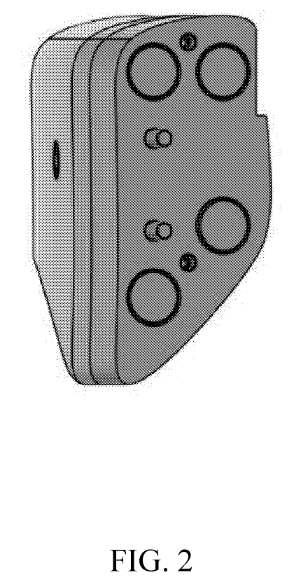

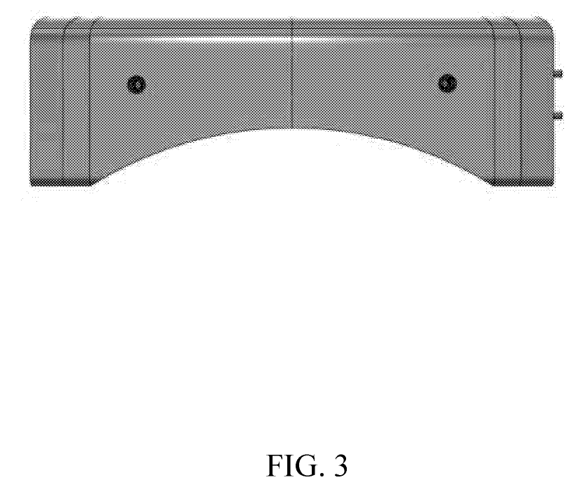

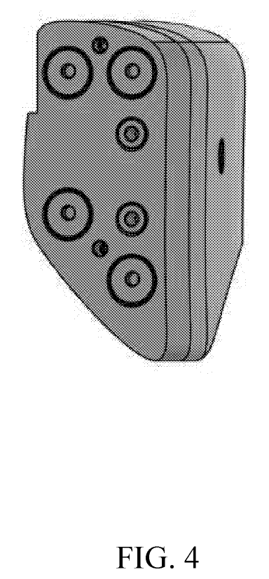

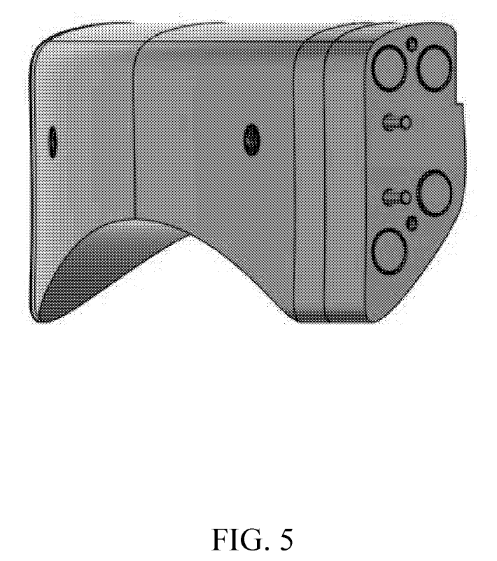

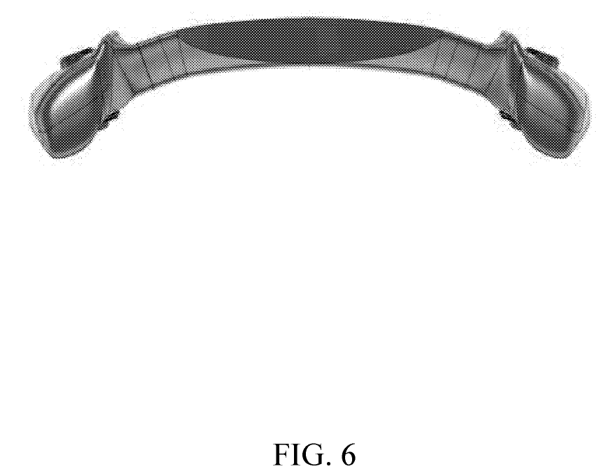

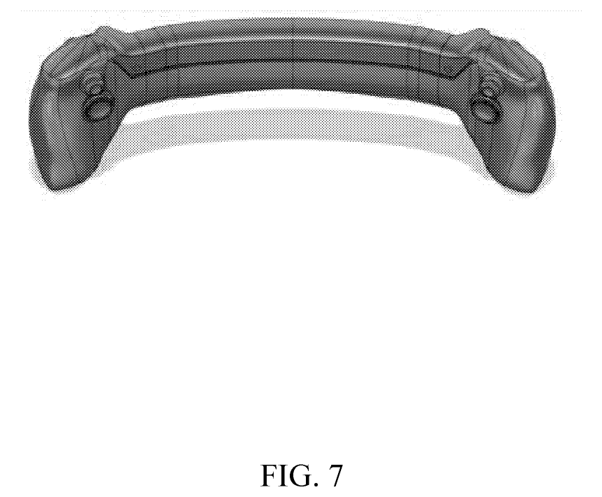

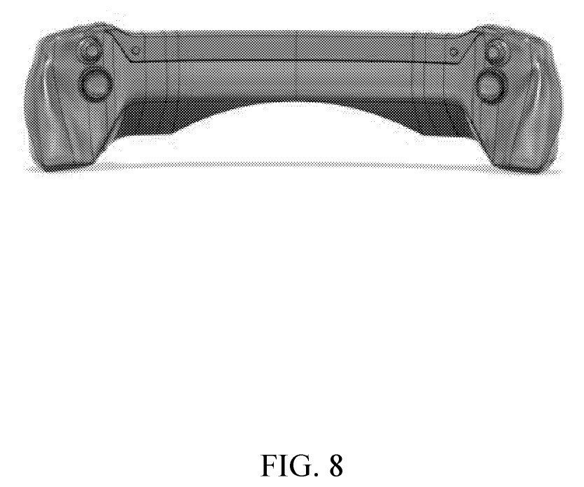

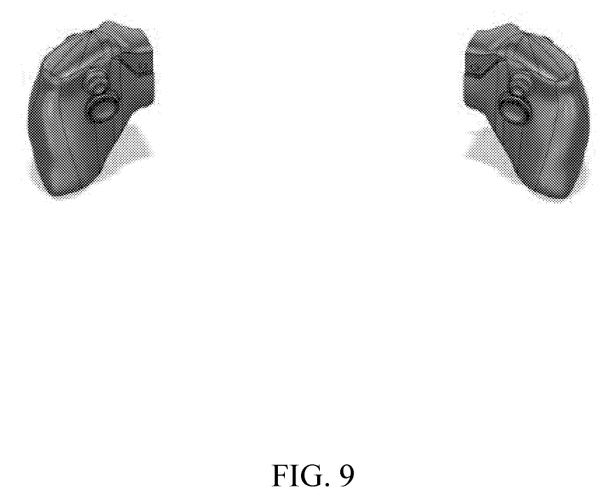

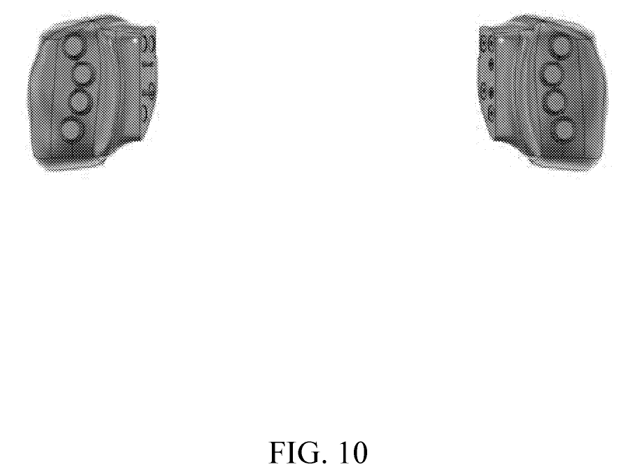

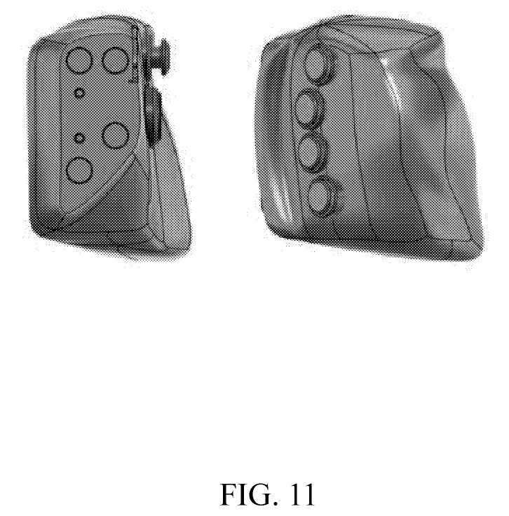

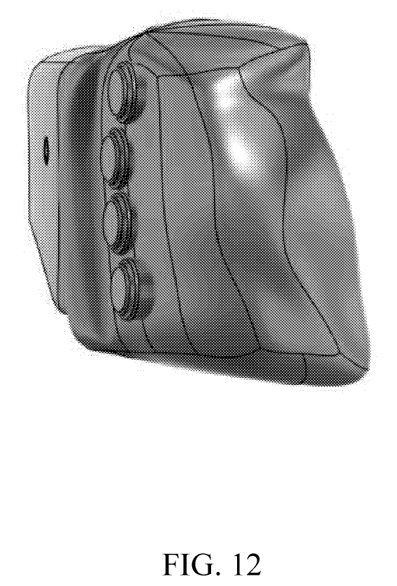

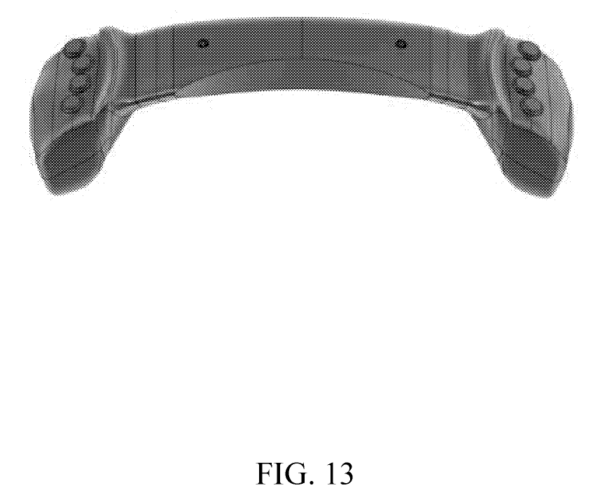

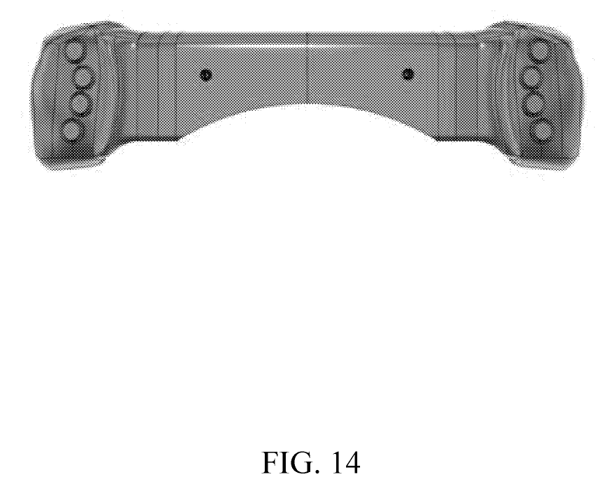

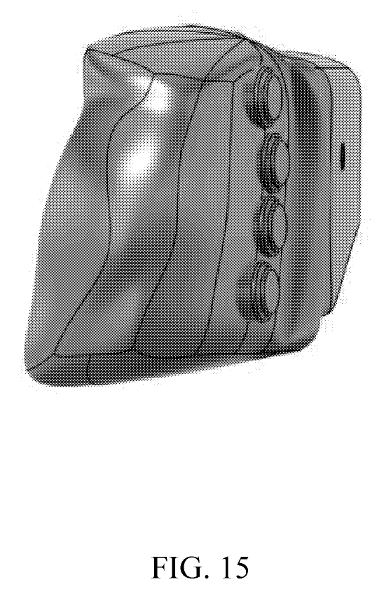

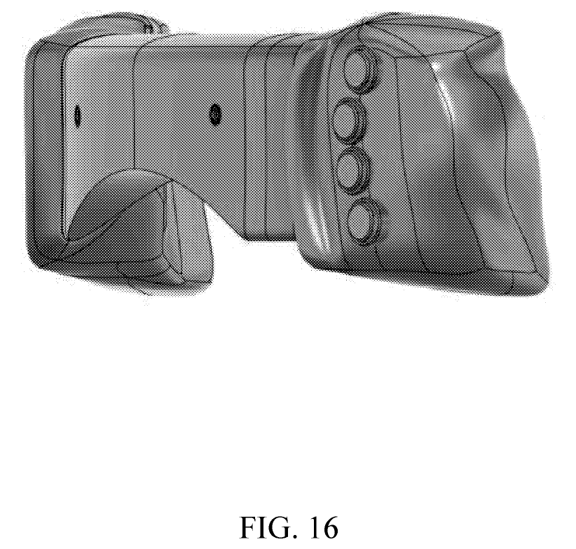

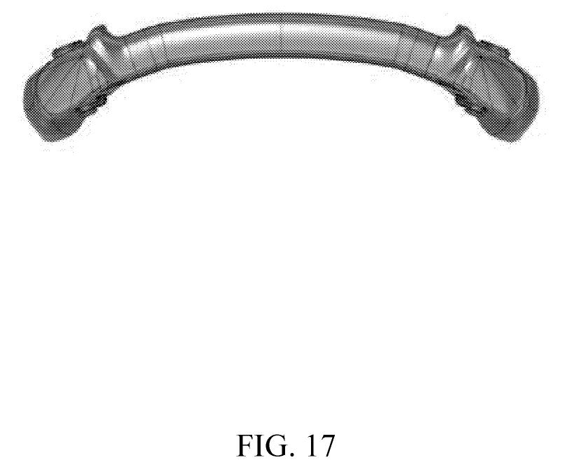

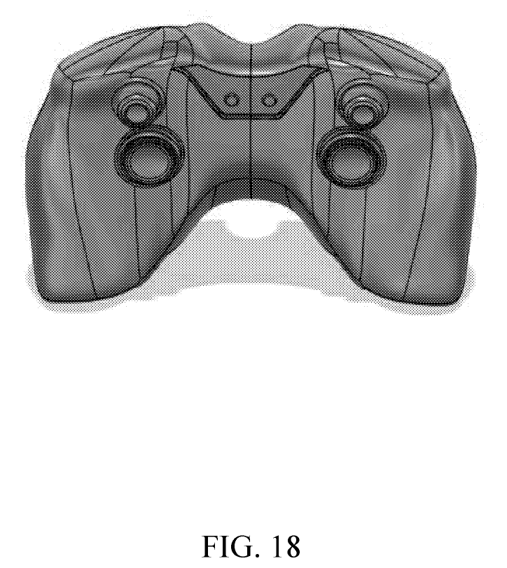

As can be seen in FIGS. 1-18, the present invention, herein referred to as, “Ergonomic Modular Video Game Controller”, is an ergonomic and modular video game controller designed to reduce physical strain and enhance gaming performance by aligning with the natural contours and movement range of the human hand. The controller features symmetrical left and right halves connected optionally by a center bridge that widens the grip and improves spinal posture. Each half includes analog thumb sticks, directional pads, a utility button, and rear-mounted finger buttons that allow simultaneous use of thumbs and fingers. Magnetic connectors, alignment pins, bushings, and pogo pin contacts enable secure assembly and electrical connectivity. The design improves comfort, response time, and hand health during extended gameplay sessions.

Ergonomic Modular Video Game Controller introduces a more efficient and more comfortable controller that can be used for video games. The controller design accommodates better posture while operating for extended durations. The benefits from using this more ergonomically designed controller leads to improved comfort, spinal and joint health. This design is intended to reduce hand strain and tension, which would otherwise result from having to reach beyond the natural range of motion that would be comfortable to operate the controller’s thumb sticks, d-pads, and buttons. The contours of the controller grips (as well as the locations of the thumb sticks, d-pads, and buttons) are designed to accommodate the human hand in its most comfortable and natural relaxed position. The design achieves minimal finger/thumb travel distance and movement, thus achieving quicker response times, less strain on the hand and joints, and less likelihood of cramping of the hands or fingers when operating for extended periods of time. The removable center bridge enables wider grip positioning that allows comfortable operation in a variety of body positions.

The design is based on a “natural mapping” approach to be more comfortable and accommodate the human hand in terms of the natural grip contours, as well as thumb stick, d-pad, and button locations. This design accommodates the unique and complex shape of the human hand. The design consists of one button for each finger on each hand, located in a natural position, accommodating the different lengths of each finger, on the back side of the controller (vs. the current mainstream design of existing controllers where the main buttons are designed to be operated with the thumb, and located on the front of the controller). The controller also has symmetrically positioned dual analog thumb-sticks and directional pads (d-pads) located in a more natural position based on the shape of the human hand. The symmetric design of the left and right halves of the controller allows the design to accommodate left-handed, right-handed, and ambidextrous operation with equal comfort and convenience.

The placement of the buttons on the back side of the controller, and the thumb sticks and d-pads on the front side of the controller, allow the user to operate the thumb sticks and buttons simultaneously, or operate the d-pads and buttons simultaneously. One could also operate a thumb stick with one thumb and a d-pad with the other thumb, while pressing any or all of the 8 buttons on the back side of the controller simultaneously as well. (Conventional or mainstream video game controllers have the main buttons on the right front side, as well as the thumb sticks and d-pad in close proximity. This positioning of thumb sticks, d-pads, and buttons all on the front side requires a person to take their thumb off the right thumb stick to press any of the buttons on the right front side of the controller. This results in a person not being able to control the right thumb stick and press the buttons located on the front side of the controller, next to the right thumb stick simultaneously.)

Thumb sticks traditionally control movement and buttons traditionally activate functions in the majority of video games. There is a competitive advantage created by using this controller, in that the buttons can be pressed with the fingertips at the same time the thumb is controlling the thumb sticks, or d-pads, with each hand simultaneously. (In video games the faster you can press a button compared to your opponent, the more competitive advantage you have. In our controller design, the time spent alternating between thumb stick and button pressing with the thumb is eliminated because all 8 fingertips are in contact with all 8 buttons at all times, resulting in faster response times.)

In terms of comfort, the contours of the grips of the controller are molded from and shaped to accommodate the natural contours of the palm of the human hand. This controller is designed to be held and stabilized in the hands through the natural pressure of the palms pressing inward towards each other, while holding the controller in the hand, and not gripped or held through the use of any fingers. This allows the fingers to be free of the task of gripping the controller to hold it in place, such that they are free to operate the buttons on the back of the controller in the same manner a piano player’s fingers would be free to press the keys on a piano. The controller shell/enclosure is extruded on the back side near the buttons to act as a button guard and prevent the buttons from unintentionally being pressed if dropped and protect the buttons from potential damage in the same scenario. This extrusion also serves as “resting rails” so the controller can be laid to rest or stored in a position lying flat on its back when not in use, and preventing the buttons from coming in contact with the surface the controller is resting on.

The controller separates into 3 main parts: The left half, the right half, and the bridge. The left and right halves are symmetrical, and each half contains 1 thumb stick, 1 4-way directional-pad, and 1 extra (general utility) button on the front side, and 1 button for each finger on the back side. This makes for a total of 1 thumb stick, 1 d-pad, and 5 buttons (one on the front and 4 buttons on the back) for each half of the controller.

The bridge functions as a spacer that maintains and continues electrical connectivity while also allowing the left and right halves of the controller to be positioned further apart from each other. This wider grip while operating the controller is more comfortable to operate while leaning back (vs. being hunched forward over traditionally designed controllers, due to the requirement for such a narrow grip inherent in their design). Our controller allows the operator to be in a position where their shoulder blades are able to be closer together, due to the wider grip distance (approximately shoulder width), resulting in a higher degree of comfort and improved spinal health.

Each half of the controller connects to the other half, and/or the bridge, through the use of magnets and steel strike plates, located in the controller portions/faces where the controller halves come together and connect – the same is used for connecting the controller halves to the bridge. The controller halves and bridge also contain guiding pins to ensure proper alignment when connecting the controller halves together and/or the bridge respectively. Electrical circuits are maintained when the controller halves are connected, and this circuit connection is also maintained through the bridge when the bridge is connected between the two halves of the controller.

Components of the preferred embodiment of the present invention include:

Controller Right Side
Enclosure
Thumb Stick Mounting Pad
Button 1 Mounting Pad
Button 2 Mounting Pad
Button 3 Mounting Pad
Button 4 Mounting Pad
LED
LED - DPAD
Thumb Stick Right
Extra Button Right
DPAD - Circular Right
Button 1
Button 2
Button 3
Button 4

Controller Connection Components Right Side
Magnet 1
Magnet 2
Magnet 3
Magnet 4
Pin Stainless 1
Pin Stainless 2
Steel Strike Plate 1
Steel Strike Plate 2
Steel Strike Plate 3
Steel Strike Plate 4
Bushing Bronze 1
Bushing Bronze 2

Controller Left Side
Enclosure
Thumb Stick Mounting Pad
Button 5 Mounting Pad
Button 6 Mounting Pad
Button 7 Mounting Pad
Button 8 Mounting Pad
LED
LED - DPAD
Thumb Stick Left
Extra Button Left
DPAD - Circular Left
Button 5
Button 6
Button 7
Button 8

Controller Connection Components Left Side
Magnet 5
Magnet 6
Magnet 7
Magnet 8
Pin Stainless 3
Pin Stainless 4
Steel Strike Plate 5
Steel Strike Plate 6
Steel Strike Plate 7
Steel Strike Plate 8
Bushing Bronze 3
Bushing Bronze 4

Center Bridge
Left Enclosure
Right Enclosure
Bridge Body
Head-Set Insert Left
Head-Set Insert Right

Center Bridge Connection Components
Magnet 9
Magnet 10
Magnet 11
Magnet 12
Pin Stainless 5
Pin Stainless 6
Steel Strike Plate 9
Steel Strike Plate 10
Steel Strike Plate 11
Steel Strike Plate 12
Bushing Bronze 5
Bushing Bronze 6

The two halves of the controller are able to be connected as a standard controller, or connected to the bridge, providing a wider, more ergonomic position that alleviates strain on the wrists, shoulders, upper back, and hands. This connection is established through a system of magnets, strike plates and alignment pins/bearings, along with electrical connection being established with seven contact pogo pins. The specific definition of the components are as follows:
Dowel Pins: Cylindrical, 4mm X 16mm stainless steel.
Bearings: Sleeve, 4mm ID X 8mm OD X 8mm Length. Self-lubricating sintered bronze.
Magnets: 1/2-inch diameter X 1/8-inch width neodymium
Strike Plates: 1/2-inch diameter X 0.1-inch width alloy steel.
Pogo pin connectors: Magnetic alignment, 2A rating, 2.54mm, spring loaded, 7 contact.

Although the invention has been explained in relation to its preferred embodiment, it is to be understood that many other possible modifications and variations can be made without departing from the spirit and scope of the invention.

What is claimed is:

1. An ergonomic modular video game controller comprising:
symmetrical left and right halves being connected optionally by a center bridge;
the center bridge being configured to widen a user’s grip and to improve the user’s spinal posture;
the symmetrical left and right halves each comprising analog thumb sticks, directional pads, a utility button, and rear-mounted finger buttons;
the symmetrical left and right halves being configured to simultaneously use of the user’s thumbs and fingers; and
magnetic connectors, alignment pins, bushings, and pogo pin contacts being configured to enable secure assembly and electrical connectivity.
